(19) United States
(12) Patent Application Publication
(10) Pub. No.: US 2014/0129948 A1
(43) Pub. Date: May 8, 2014

(54) METHOD AND APPARATUS FOR SIMULTANEOUS DISPLAY OF INFORMATION FROM MULTIPLE PORTABLE DEVICES ON A SINGLE SCREEN

(71) Applicant: BANK OF AMERICA CORPORATION, Charlotte, NC (US)

(72) Inventors: Alicia C. Jones, Fort Mill, SC (US); Matthew Perkins, Charlotte, NC (US); James E. Burgess, Charlotte, NC (US); Sean M. Jones, Charlotte, NC (US); Carrie A. Hanson, Charlotte, NC (US); Caitlin Rose Chrisman, Charlotte, NC (US)

(73) Assignee: BANK OF AMERICA CORPORATION, Charlotte, NC (US)

(21) Appl. No.: 13/672,383

(22) Filed: Nov. 8, 2012

(51) Int. Cl. G06F 3/0484

(52) U.S. Cl. CPC G06F 3/0484
USPC 715/733

(57) ABSTRACT

A method is disclosed comprising storing on a first computing device having a user interface and a memory pieces of information for displaying, and providing a user interface on the first computing device an option for displaying the pieces of information stored on the first computing device onto a common display area while sharing the common display area with a second computing device. The second computing device is allowed to also display pieces information from the second computing device simultaneously with the first computing device on the common display area. The first computing device comprises a camera, and the first computing device is configured to capture images for display onto the common display area. The pieces of information can relate to properties. The common display area can be projected onto a display unit or multiple display units.

### TECHNICAL FIELD

Aspects of the disclosure relate to the display of information on a single shared user interface or display area from multiple computing devices.

### BACKGROUND

The disclosure herein relates to an application or system that assists users with evaluating items or services under consideration by providing a unified system permitting multiple users to search for any item or service to collect information, such as images, locations, or prices, for sharing with other users involved with the evaluation process. In one exemplary embodiment, multiple users can acquire images of potential items for purchase with a wireless-enabled device and display the images onto a common display area for viewing by multiple users simultaneously on a common screen or the common display area can be viewed on multiple screens by various users simultaneously. For example, the application can provide for multiple users to push their content to a common viewing area where everyone can collaboratively view the users' respective content and comment to make a collaborative decision regarding the items or services under consideration.

### BRIEF SUMMARY

The following presents a simplified summary of the disclosure in order to provide a basic understanding of some aspects of the invention. It is not intended to identify key or critical elements of the invention or to delineate the scope of the invention. The following summary merely presents some concepts of the invention in a simplified form as a prelude to the more detailed description provided below.

In an exemplary embodiment, a computer-implemented method is disclosed comprising configuring a first computing device to provide an option on a user interface of the first computing device for displaying pieces of information onto a common display area while sharing the common display area with a second computing device. The second computing device is also allowed to display pieces of information simultaneously with the first computing device on the common display area.

In another exemplary embodiment, the pieces of information relate to properties, and the pieces of information include one or more of images of the properties, locations of the properties, costs of the properties, and size of the properties. The method further comprises configuring the first computing device to collect and store pieces of information for displaying the pieces of information onto the common display area and providing the first computing device with additional information relating to additional properties based on the pieces of information relating to the properties.

In another exemplary embodiment, the method comprises providing the user interface of the first computing device with an option to display the information relating to the additional properties onto the common display area and providing the first computing device user interface with an option to provide information relating to a prequalification letter of approval for a particular loan product. The common display area can be projected onto a display unit for viewing by multiple users or the common display area can be projected onto multiple display units for viewing by multiple users in different locations simultaneously.

In another exemplary embodiment, an apparatus is disclosed comprising a processor for executing computer-executable instructions; and one or more memories storing the computer-executable instructions that, when executed, cause the apparatus to perform a method comprising: providing a user interface on a first computing device with an option for displaying pieces of information onto a common display area while sharing the common display area with a second computing device while allowing the second computing device to also display pieces information simultaneously with the first computing device on the common display area.

In another exemplary embodiment, a computer-implemented method is disclosed comprising: configuring a common display area to receive pieces of information from a plurality of computing devices and displaying the pieces of information onto the display area by partitioning the common display area to simultaneously display the pieces of information from the plurality of computing devices.

In another exemplary embodiment, a computer program product is disclosed, comprising a computer usable medium having a computer readable program code embodied therein, the computer readable program code is adapted to be executed by a processor to implement a method comprising: storing on a first computing device having a user interface and a memory pieces of information for displaying, and providing a user interface on the first computing device an option for displaying the pieces of information stored on the first computing device onto a common display area while sharing the common display area with a second computing device. The second computing device is also allowed to display pieces information from the second computing device simultaneously with the first computing device on the common display area. The first computing device comprises a camera, and the first computing device is configured to capture images for display onto the common display area.

Aspects of the invention may be provided in a computer-readable medium having computer-executable instructions to perform one or more of the process steps described herein.

These and other aspects of the invention are discussed in greater detail throughout this disclosure, including the accompanying drawings.

### BRIEF DESCRIPTION OF THE DRAWINGS

The present disclosure is illustrated by way of example and not limited in the accompanying FIGURES in which like reference numerals indicate similar elements and in which:

FIG. 1 shows an illustrative operating environment in which various aspects of the invention may be implemented.

FIG. 2 illustrates an exemplary embodiment in accordance with the invention.

### DETAILED DESCRIPTION

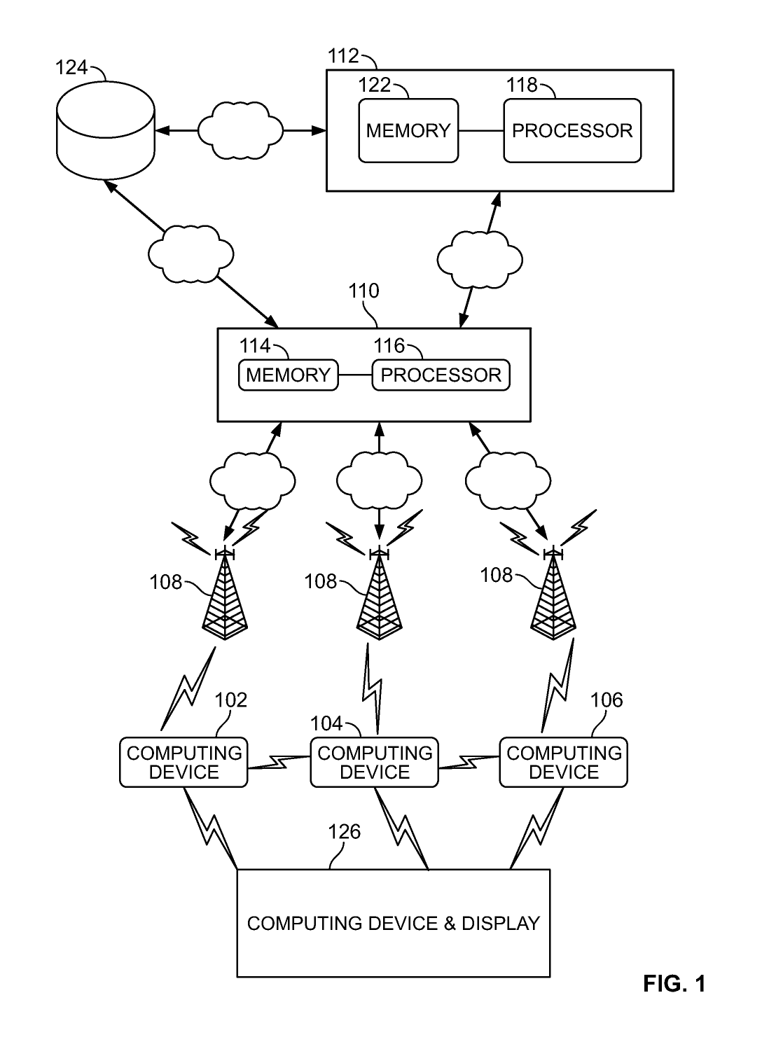

FIG. 1 depicts an illustrative operating environment in accordance with aspects of the disclosure. Computing devices 102, 104, 106, 126 are configured for wireless transmission and connect to each other, the various components described herein, as well as other computing devices through the wireless access points 108. It is also contemplated that these connections can be accomplished by any known connection between the computing devices 102, 104, 106, and the computing device and display 126. For example, the above connections can be made via the internet, blue tooth, WiFi, infrared, or any other known method of wireless transmission. The computing devices 102, 104, 106, 126 may be mobile telephones or smartphones with applications and other functionality, a handheld device with Wi-Fi or other wireless connectivity (e.g., wireless enabled tablets, tablet computers, PDAs, and the like), displays with built-in or external memories and processors, or any other known computer, computing device, or handheld computer. Although as described herein below each of the computing devices 102, 104, 106, and 126 can include a display, computing device 126 can include a larger display for viewing by multiple users. Additionally, computing device 126 can act as a common display unit configured to display information from each of the computing devices 102, 104, 106.

The computing devices 102, 104, 108, 126 can be enabled to communicate with the wireless access points 108 which can be a series of cellular towers hosted by a service provider. Additionally, the wireless access points 108 may be Wi-Fi (e.g., compatible with IEEE 802.11a/b/g/ and the like wireless communication standards) connections and the computing devices 102, 104, 106, 126 may obtain access to the Internet at these connections. Other known techniques may be used to allow devices 102, 104, 106, 126 to connect with a network.

A server 110 can receive data communicated from the computing devices 102, 104, 106, 126. Server 110, for example, a high-grade computer, may include a processor 116 for executing computer-readable instructions and a memory 114 for storing the computer-readable instructions. The devices 102, 104, 106, 126 may transmit data to the server 108 over the network through the wireless access points 108. A second server 112 may be comprised of a processor 118 for executing the computer-readable instructions and a memory 122 for storing computer-readable instructions in accordance with aspects of the disclosure. Computer data that may be useful to various applications running on the devices 102, 104, 106, 126 or the servers 110, 112 may be stored on the memories 114, 122. For example, the computer data may include security information, bank account information, user login/profile information, service provider list and related information, and/or other information. This data may also be used to support one or more of the numerous features disclosed throughout this disclosure.

The servers 110, 112 are not limited to a single machine or device. For example, the server 110 or 112 may be implemented as a web server, Internet-accessible server, or cloud-based server. Furthermore, the term server refers to any system of computers and/or arrangement of devices (e.g., firewalls, routers, caching systems, proxy servers, and the like or combination thereof) that may be used to provide a connection to services and features available for use. As such, different reference to the server performing particular steps does not require that the same machine/device perform all the steps.

The wireless access points 108, servers 110, 112, and the data store 124 can be configured to communicate over a wireless connection or a wired connection. In certain examples, a secure and private link can be created between one or more of these devices. For example, a network cloud representing the Internet can be used to link the server 110, the data store 124, and the server 112. Alternatively, a secure WAN or a dedicated Ti (or other telecommunications line) may connect the servers 110, 112 and the data store 124.

It is also contemplated that the devices 102, 104, 106, 126 may include memories, processors, display screens (e.g., touchscreens), keypads, cameras, sensors (e.g., motion, light, and the like), global positioning system (GPS) components, audio output/input devices, and other electronic components configured for use in mobile phones, tablets, PDAs, mini-laptops, or other computing devices.

Additionally, the servers 110, 112 may include processors, memories (RAM, ROM), communications modules, and/or memories for storing operating systems, applications, and/or data. The servers may have processors for controlling overall operation of the servers and their associated components, including random access memories, read-only memories, communications modules, and other types of memories. Such servers may include a variety of computer readable media. The computer readable media can be any available media, including tangible and intangible, that can be accessed by the servers and includes both volatile and nonvolatile media, and removable and non-removable media. By way of example, and not limitation, computer readable media may include a combination of computer storage media and communication media.

Computer storage media includes volatile and nonvolatile, removable and non-removable media implemented in any method or technology for storage of information such as computer readable instructions, object code, data structures, program modules or other data. Computer storage media include, but are not limited to, random access memory (RAM), read only memory (ROM), electronically erasable programmable read only memory (EEPROM), flash memory or other memory technology, CD-ROM, digital versatile disks (DVD) or other optical disk storage, magnetic cassettes, magnetic tape, magnetic disk storage or other magnetic storage devices, or any other medium that can be used to store the desired information and that can be accessed by the server.

The aforementioned server may include one or more applications representing the application data stored in RAM memory while the server is on and corresponding software applications (e.g., software tasks) are running on the server. The aforementioned communications module may include a microphone, keypad, touch screen, and/or stylus through which an (optional) user of the server may provide input, and may also include one or more of a speaker for providing audio output and a video display device for providing textual, audio/visual and/or graphical output. Software may be stored within the memory and/or storage to provide instructions to the processor for enabling the server to perform various functions. For example, memory may store software used by the server, such as an operating system, application programs, and/or an associated database. Alternatively, some or all of the computer executable instructions for the server may be embodied in hardware or firmware. Moreover, a database (or data store) 124 may provide centralized storage of data.

Such a server may operate in a networked environment supporting connections to one or more remote computing devices. The remote computing devices may be personal computing devices or servers that include many or all of the elements described above relative to the server. Remote computing devices may be a mobile device communicating over wireless carrier channel. The network connections depicted in FIG. 1 may include a local area network (LAN) and/or a wide area network (WAN), but may also include other networks. When used in a LAN networking environment, the server may be connected to the LAN through a network interface or adapter in the communications module. When used in a WAN networking environment, the server may include a modem in the communications module or other means for establishing communications over the WAN, such as the Internet. It will be appreciated that the network connections shown and described are illustrative and other means of establishing a communications link between the devices may be used. The existence of any of various well-known protocols such as TCP/IP, Ethernet, FTP, HTTP and the like is presumed, and the system can be operated in a client-server configuration to permit a user to retrieve web pages from a web-based server. Any of the various commonly known web browsers can be used to display and manipulate data on web pages.

As understood by those skilled in the art, the system and steps that are disclosed herein and in the FIGURES may be implemented by one or more of the components in FIG. 1 and/or other components, including other computing devices. The systems and applications disclosed herein can be implemented in various forms for example, a website, smart phone application, tablet application, or other portable device application.

In one exemplary embodiment, an application that assists users with evaluating a plurality of items or services by providing a unified system permitting multiple users to search for any item or service to collect information. The users can then share the images with other users involved with the evaluation process on a common display area. For example, a user can take a picture of a potential item or property under consideration, and the user can place the picture onto a common display area, which can be viewed by multiple users on a common screen or can be viewed on multiple screens by various users in different locations simultaneously.

In another example, the user could conduct a search using one or more databases for a particular type of property, item, or service under consideration, and the user can place the property, item, or service of interest from the set of search results onto a common display area. This searching can be done in accordance with any known method including the methods described in U.S. patent application Ser. No. 13/069,796, which is incorporated by reference in its entirety.

The application can provide for multiple users to push selected content to a common viewing area where all of the users can collaboratively view the users' respective content and comment to arrive at a collective decision regarding the items, properties, or services under consideration.

The system could be used in the evaluation of any type of property, item, or services under consideration or that requires a collaborative decision making process. For example, the methods disclosed herein could be used for the evaluation of properties, investments, televisions, cars, boats, contractors, nannies, and the like. By permitting the users to each display content for consideration on a common viewing area, each of the users involved with the decision making process can provide feedback and comments. Based on the feedback and comments from each of the users a decision can be made collaboratively within the group of users.

In one exemplary embodiment, the system herein provides for the display of information on a single shared user interface or screen from multiple devices via wireless transmission from the portable devices to the single shared display area. The system can be implemented as an application on each of the users' computing devices or integrated as a feature as part of another application, such as a real estate searching application, for example. Each of the individual users can independently search and/or collect information for displaying to all of the users collectively on a single shared display area, which can be projected onto one display unit or multiple display units simultaneously if the users are not in a common location.

In another exemplary embodiment, when a user takes a picture of a property under consideration, the application can determine the location of the user and, therefore, the location of the property. Alternatively, the application can be linked to an online database, for example the Multiple Listing Service (“MLS”), and the application can look up the property information on the MLS and receive data regarding the property. All of the information, including images of the property, can be placed in a cue, for displaying on a common display area for viewing by multiple users on a common screen or for displaying on multiple screens simultaneously if the users are in different locations.

To display content on the common display area, the users' devices can be provided with various options to display the information. In one example, the user interface on the users' devices can be provided with a checkbox or selection tool that provides an option for the user to display the information on the users' device on the common graphical user interface. The checkbox feature can be a toggle-like graphical user interface in which the user can select the image for displaying with an input device, such as a touch screen, stylus, keypad, and the like. Alternatively, the graphical user interface can be configured such that the user can select content with the input device on the user's computing device by highlighting or circling the information to be displayed. In another example, the user device graphical user interface, can be provided with a drag and drop area, and the user can simply drag information from the screen on the user device into the drag and drop area for displaying the information onto the common display area. However, other techniques for displaying the content on the common display area are also contemplated.

The graphical user interface on the users' computing devices can also provide a feature for providing various sorting, arranging, and selecting of the content that is to be displayed on the common display area. For example, the graphical user interface can provide for the user to select a certain order of images for viewing on the common display area or the graphical user interface can offer default settings, such as arranging the properties by price, size, proximity to a predetermined location, and the like. The common display area can also be configured to overlay the content from the users on a map so that the users can see where exactly each property is located with respect to other properties being pushed to the screen by other users.

The graphical user interface of the user's computing device can also provide for certain types of information to be displayed along with other content, such as price, location, square footage, number of bedrooms and bathrooms, school district information, and the like. The graphical user interface can provide for various selection options to display this information including the selection options discussed herein. This information can be linked to particular properties stored in the user's computing device. The information can be manually updated for each property or the information can be downloaded automatically, using the MLS for example, for each property under consideration or stored in the user's application. However, other techniques for providing various sorting, arranging, and selecting of the content that is to be displayed on the common display area are also contemplated.

The display area can be divided in any desired fashion for displaying the information from each user. For example, the common display area can be divided in rows and columns or divided in sections (e.g. halves, thirds, quarters, and the like) depending on how many users are inputting information to the common display area at the same time. One or more of the users' computing devices can be provided with various settings for a particular user or users to select a particular displaying method.

In an exemplary embodiment, the computing devices can communicate with the common display area to determine the display arrangement of the information. In this way, the common display area can be configured to display the information from each of the user interfaces in a cue from each device or can provide partitions on the display for displaying information from each user device controlling the content on the screen. Alternatively, each of the devices can communicate with each other to divide up and output information onto the common display.

The common display area can also include identifying information for each of the users to highlight which user is providing content or can associate particular pieces of information with each user. For example, names of individuals, names of devices, devices types, characters, numbers, color, and the like can be used to indicate which user is providing the particular content onto the common display. The common display area can also be configured for displaying of information anonymously by each of the users.

The common display area can also be configured such that users can include notes under each property. This feature may be helpful for the users to provide real time notes and feedback onto the screen and make notes or charts of the pros and cons for each property. The notes and feedback can be stored on a server, the memory of the display unit, in the memories of the users computing devices, or any other suitable location for viewing later by each of the individual users through use of one or more applications on the users' computing devices. This information can then be recalled in another viewing session, if the users need to continue the evaluation session at a later time and or date. The application can also provide for an option to provide for communication over the devices, such as voice, text messaging, email, and the like. This feature may be beneficial to the users if they are located in different locations.

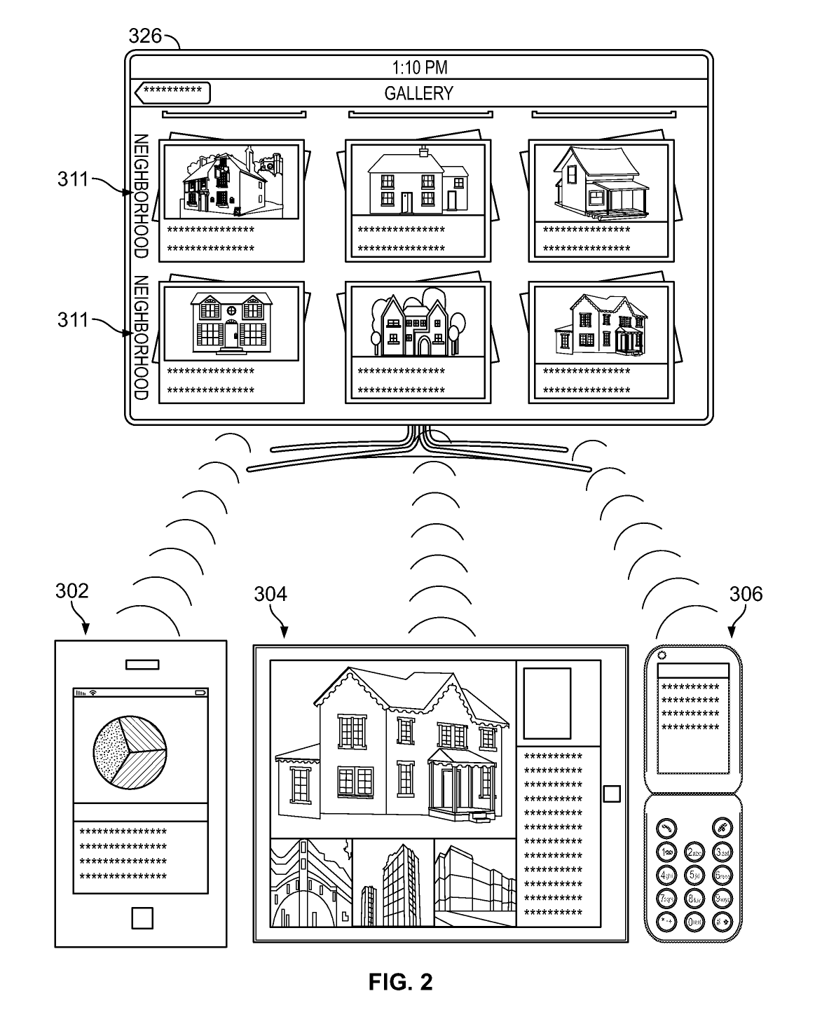

FIG. 2 depicts an exemplary embodiment of a method for the displaying of information on a common display unit 326 from multiple portable devices. FIG. 2 illustrates several personal devices 302, 304, and 306, such as cell phones, smart phones, tablets, portable computers, or other computing devices that can be configured to display separate information onto a common display unit 326, such as a computer monitor or television screen. In this way, each user can view information from each of the personal devices 302, 304, and 306 on one common display unit 326. Although three devices 302, 304, and 306 are depicted in the example in FIG. 2, it is also contemplated that a single device, two devices, or more than three devices can display information onto the common display unit 326.

In the example shown in FIG. 2, the users can share information relating to various properties for sale. In this example, each of the devices 302, 304, 306 is projecting images of different properties for sale onto the screen. Each device 302, 304, 306 can also display relevant information regarding the property onto the screen, such as price, location, number of bedrooms and bathrooms, as well as the amount of square footage of each property. The information can be displayed in rows and columns and can be sorted by neighborhood information 311. This can be customized by the users via a central control, which can be accessed on one or more of the users' devices application settings. In this example, the application can be beneficial for property shopping in that each of the users can provide input onto a common screen for vetting by all of the users. Additional options can be provided on the common display unit 326, such as financing, applying for a showing, school information, monthly mortgage payment amounts, and the like.

Additionally the party hosting the application can push content to the common display unit 326. For example, if the users are considering various properties for purchase, the party hosting the application can recommend other similar properties in similar locations to the users and can provide various information on those properties such as price, location, square footage, number of bedrooms and bathrooms, school information, property taxes, and the like. In this way, the host of the application can direct users to properties that the host may be financially interested in selling to advertise particular properties. This content could be pushed to the users' devices 320, 304, 306 or to the common display unit 326. The application host can also provide to the users advertisements for various loans and can calculate a mortgage payment based on a particular property. The host may comprise a realtor or a broker, for example.

The application could also be configured to virtualize the process of obtaining prequalification letters for the users. The prequalification letter application could be displayed on the application such that the user could fill out the application on the user's device, or the application could be configured to email the prequalification application directly to the user. One the particular applicant is approved, the prequalification letter could be sent directly to the user's device on an application such that the user could display the prequalification letter to an agent or a bar code could be provided to the user's device for reading by an agent's scanner or reader. The agent could then view on his/her computing device, for example, smartphone or tablet the prequalification letter or whether the buyer is qualified for a particular property. However, other known methods are also contemplated.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

We claim:

1. A computer-implemented method comprising:
configuring a first computing device to provide an option on a user interface of the first computing device for displaying pieces of information onto a common display area while sharing the common display area with a second computing device wherein the sharing allows the second computing device to also display pieces of information simultaneously with the first computing device on the common display area.

2. The computer-implemented method of claim 1 wherein the pieces of information relate to properties.

3. The computer-implemented method of claim 2 wherein the pieces of information include one or more of images of the properties, locations of the properties, costs of the properties, and size of the properties.

4. The computer-implemented method of claim 1 further comprising configuring the first computing device to collect and store pieces of information for displaying the pieces of information onto the common display area.

5. The computer-implemented method of claim 2 further comprising providing the first computing device with additional information relating to additional properties based on the pieces of information relating to properties.

6. The computer-implemented method of claim 5 further comprising providing the user interface of the first computing device with an option to display the information relating to the additional properties onto the common display area.

7. The computer-implemented method of claim 1 further comprising providing the first computing device user interface with an option to provide information relating to a prequalification letter of approval for a particular loan product.

8. The computer-implemented method of claim 1 wherein the common display area is projected onto a display unit for viewing by multiple users.

9. The computer-implemented method of claim 1 wherein the common display area is projected onto multiple display units for viewing by multiple users in different locations.

10. An apparatus comprising:
a processor for executing computer-executable instructions; and
one or more memories storing the computer-executable instructions that, when executed, cause the apparatus to perform a method comprising:
providing a user interface on a first computing device with an option for displaying pieces of information onto a common display area while sharing the common display area with a second computing device wherein the sharing allows the second computing device to also display pieces of information simultaneously with the first computing device on the common display area.

11. The apparatus of claim 10 wherein the pieces of information relate to properties.

12. The apparatus of claim 11 wherein the pieces of information include one or more of images of the properties, locations of the properties, costs of the properties, and size of the properties.

13. The apparatus of claim 10 further comprising configuring the first computing device to collect and store pieces of information for displaying the pieces of information onto the common display area.

14. The computer-implemented method of claim 10 wherein the common display area is projected onto a display unit for viewing by multiple users.

15. The computer-implemented method of claim 10 wherein the common display area is projected onto multiple display units for viewing by multiple users in different locations.

16. A computer-implemented method comprising:
configuring a common display area to receive pieces of information from a plurality of computing devices; and
displaying the pieces of information onto the display area by partitioning the common display area to simultaneously display the pieces of information from the plurality of computing devices.

17. The apparatus of claim 16 wherein the pieces of information relate to properties.

18. The apparatus of claim 17 wherein the pieces of information include one or more of images of the properties, locations of the properties, costs of the properties, and size of the properties.

19. The computer-implemented method of claim 16 wherein the common display area is projected onto a display unit for viewing by multiple users.

20. The computer-implemented method of claim 16 wherein the common display area is projected onto multiple display units for viewing by multiple users in different locations.

21. A computer program product, comprising a computer usable medium having a computer readable program code embodied therein, said computer readable program code adapted to be executed by a processor to implement a method comprising:
storing on a first computing device having a user interface and a memory pieces of information for displaying; and
providing a user interface on the first computing device with an option for displaying the pieces of information stored on the first computing device onto a common display area while sharing the common display area with a second computing device wherein the sharing allows the second computing device to also display pieces of information from the second computing device simultaneously with the first computing device on the common display area.

22. The apparatus of claim 22 wherein the pieces of information relate to properties.

23. The apparatus of claim 23 wherein the pieces of information include one or more of images of the properties, locations of the properties, costs of the properties, and size of the properties.

24. The apparatus of claim 22 wherein the first computing device comprises a camera and wherein the first computing device is configured to capture images for display onto the common display area.
